(19) United States
(12) Patent Application Publication
(10) Pub. No.: US 2023/0093985 A1
(43) Pub. Date: Mar. 30, 2023

(54) PROVIDING A HYBRID VIRTUAL NETWORK

(71) Applicant: LENOVO (UNITED STATES) INC., Morrisville, NC (US)

(72) Inventors: RADU MIHAI IORGA, BUCHAREST (RO); MIROSLAV HALAS, CHAPEL HILL, NC (US); ROBERTO H. JACOB DA SILVA, OAK PARK, CA (US); MIHAI-COSTIN BROC, BUCHAREST (RO); CORNELIU-ILIE CALCIU, BUCHAREST (RO)

(21) Appl. No.: 17/490,351

(22) Filed: Sep. 30, 2021

(51) Int. Cl. G06F 9/455; H04L 12/46

(52) U.S. Cl. CPC G06F 9/45558; H04L 12/4633; G06F 2009/45595; H04L 2212/00

(57) ABSTRACT

Providing a hybrid virtual network, includes: receiving from a source VM, by a hypervisor of a first stack, a packet to be transmitted to a target VM within a virtual network includes multiple VMs spanning a multiple stacks, where each stack includes an aggregation of compute, storage, and network resources and separate stacks are coupled for data communications via a network level protocol; if the target VM is located in the first stack, overwriting a MAC address of in the packet with a replacement MAC address for transmission via a data link layer protocol and transmitting the packet with the data link layer protocol; and if the target VM is not located in the first stack, encapsulating the packet for tunneling via a network layer protocol and transmitting the encapsulated packet with the network layer protocol.

### BACKGROUND

A cloud environment may be formed of many different components of a computing system. Some cloud environments may be on-premises, some off-premises, and some may be formed of both. Further, some cloud systems may be formed on demand. Consider, for example, a composable infrastructure in which various computing components from a pool of available components may be selected for operation as a private data center or as an on-premises private cloud. In such a composable infrastructure aggregations of compute resources, storage resource, and network resources that operate as a single private data center (in most cases on-premises) are referred to as ‘stacks.’ That is, a stack is aggregation of compute resources, storage resources, and network resources. A ‘stack’ in some cases implements a private cloud. Virtual machines (‘VMs’) that operate within each stack must communicate with one another, typically within a virtual network. Moreover, VMs from separate stacks can be coupled for data communications in the same virtual network.

Within a stack, VMs could utilize a layer 2 network solution for high bandwidth, efficient data communications with other VMs in the stack. Such an approach is faster than tunneling solutions between VMs. However, the layer 2 network solution cannot be extended within the same virtual network between different physical stacks.

### SUMMARY

Methods, systems, and apparatus for providing a hybrid virtual network are disclosed in this specification. Providing a hybrid virtual network according to embodiments of the present disclosure includes receiving from a source VM (‘virtual machine’), by a hypervisor of a first stack, a packet to be transmitted to a target VM within a virtual network. The virtual network includes a plurality of VMs spanning a plurality of stacks. Each stack includes an aggregation of compute resources, storage resources, and network resources. Separate stacks are coupled for data communications via a network level protocol. Providing the hybrid virtual network also includes determining whether the target VM is located in the first stack. If the target VM is located in the first stack, the hypervisor overwrites a MAC (‘Media Access Control’) address of the target VM in the packet with a replacement MAC address for transmission via a data link layer protocol and transmits the packet with the data link layer protocol. If the target VM is not located in the first stack, the hypervisor encapsulates the packet for tunneling via a network layer protocol and transmits the encapsulated packet with the network layer protocol.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 sets forth a block diagram of an example system configured for providing a hybrid virtual network according to embodiments of the present disclosure.

FIG. 2 sets forth a flow chart illustrating an exemplary method for providing a hybrid virtual network according to embodiments of the present disclosure.

FIG. 3 sets forth a flow chart illustrating a variation of the previous method of providing a hybrid virtual according to embodiments of the present disclosure.

### DETAILED DESCRIPTION

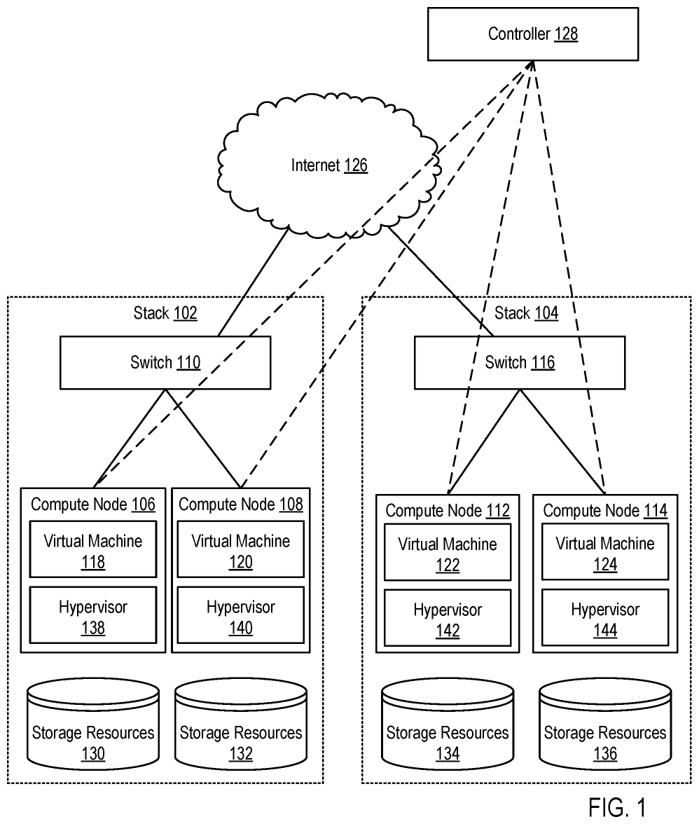

Exemplary methods, apparatus, and products for providing a hybrid virtual network in accordance with the present disclosure are described with reference to the accompanying drawings, beginning with FIG. 1. FIG. 1 sets forth a block diagram of an example system configured for providing a hybrid virtual network according to embodiments of the present disclosure. The system of FIG. 1 includes two stacks (102, 104). Each stack includes and is defined by an aggregation of compute resources, storage resource, and network resources that generally operate as a single private data center. Each stack (102, 104) can be implemented in a separate physical location or in the same physical location.

Each stack (102, 104) includes a number of compute nodes (106, 108, 112, 114), one or more switches (110, 116), and storage resources (130, 132, 134, 136). Each of the compute nodes (106, 108, 112, 114) executes a hypervisor (138, 140, 142, 144) that hosts or supports execution of a virtual machine (118, 120, 122, 124). Each of the compute nodes may be configured with processors, computer memory, and other computing components required to execute the virtual machines and hypervisors. Additionally, the hypervisors may support many more than one virtual machine at a time. Each of the VMs may execute a host operating system and various applications.

The VMs and compute nodes (106, 108, 112, 114) are coupled for data communications through the switches (11, 116) and the wide area network in the form of the internet (126). The configuration of the stacks (102, 104) as depicted in FIG. 1 is for example only, not limitation. Readers will recognize that stacks may include any number of compute nodes, any number and type of storage resources, and any number of switches or other networking components. Additionally, systems configured for providing a hybrid virtual network may include any number of stacks and be coupled through any number of networks.

The VMs in the example of FIG. 1 are configured in a virtual network. Data communication packets can be transmitted between virtual machines according to a variety of different protocols. To that end, each of the stacks (102, 104) of FIG. 1 is configured to provide a hybrid virtual network. In fact, the controller (128) of FIG. 1 provides configuration details to the hypervisors of each compute nodes, specifying various data communications parameters of VMs. In some embodiments, the controller (182) —which may be implemented as an aggregation of computer hardware and software and be accessible by the hypervisors via the internet or another network—may, upon instantiation of a new VM, inform the hypervisor hosting the VM of the VM's MAC address, the virtual network of the VM, the VM's IP address, other VMs in the same virtual network, and the like.

Each hypervisor may then control data communications originating from VMs hosted by the hypervisor in accordance with a hybrid virtual network protocol. For example, the hypervisor (138) receives from a source VM (118), a packet to be transmitted to a target VM within a virtual network. The hypervisor (138) then determines whether the target VM is located in the same stack (102) as the source VM (118). If the target VM is located in the same first stack (such as VM 120), the hypervisor (138) overwrites a MAC address of the target VM in the packet with a replacement MAC address for transmission via a data link layer protocol. In some embodiments, the replace MAC address is the MAC address of the ‘destination’ hypervisor; that is the hypervisor hosting the target VM. The source hypervisor then transmits the pack with the data link layer protocol.

The data link layer protocol is a layer 2 or L2 protocol in the seven-layer OSI model and is between the physical layer and the network layer (layer 3 or L3). The switch (110) in the example of FIG. 1 in the stack (102) can be an L2 switch. Consider, for example, that the target VM of the packet (or ‘frame’ if the data communication was originally a layer 2 ethernet frame) is the virtual machine (120) hosted by the hypervisor (140). In such an example, rather than sending the packet to the VM (120) through the layer 3 network (the Internet), the hypervisor (138) replaces the original MAC address with the hypervisor's (140) MAC address and sends the packet to the hypervisor through the switch (110) using a layer 2 protocol. In this way, the packet can be very quickly transmitted between compute nodes & hypervisors within the same stack (102) without traveling out of the stack to another network and back.

If the target VM is not located in the first stack (102), however, the layer 2 communication cannot be carried out. Instead, the hypervisor (138) encapsulates the packet for tunneling via a network layer protocol and transmits the encapsulated packet with the network layer protocol (L3 protocol). In some embodiments, the hypervisor encapsulates a packet using the VXLAN (Virtual eXtensible Local Area Network) protocol. VXLAN is an encapsulation protocol that provides connectivity using tunneling to stretch Layer 2 connections over an underlying Layer 3 network. In an example in which the target VM is the VM (122) hosted by hypervisor (142) in the second stack (104), the hypervisor (138) of the first stack (102) may identify the VM (122) as the target VM from the information in the packet, determine the VM is not in the same stack and encapsulate the packet using, as the destination IP (Internet Protocol) address, the IP address of the hypervisor (142). The packet will then be transmitted through the internet (126) via TCP/IP to the hypervisor (142). The hypervisor (142) will remove the encapsulation, identify from the unencapsulated packet the destination MAC address of the target VM (122) and provide the packet to the VM.

In this way, each hypervisor supports L2 communications within the stack through overwriting of destination MAC addresses and supports L3 communications with other stacks through tunneling and encapsulation. In this way, the virtual network coupling the VMs is said to be ‘hybrid.’ The L2 with MAC overwrite protocol enables extremely low latency data communications within the stack and the L3 encapsulation extends the L2 communications between physically separated stacks.

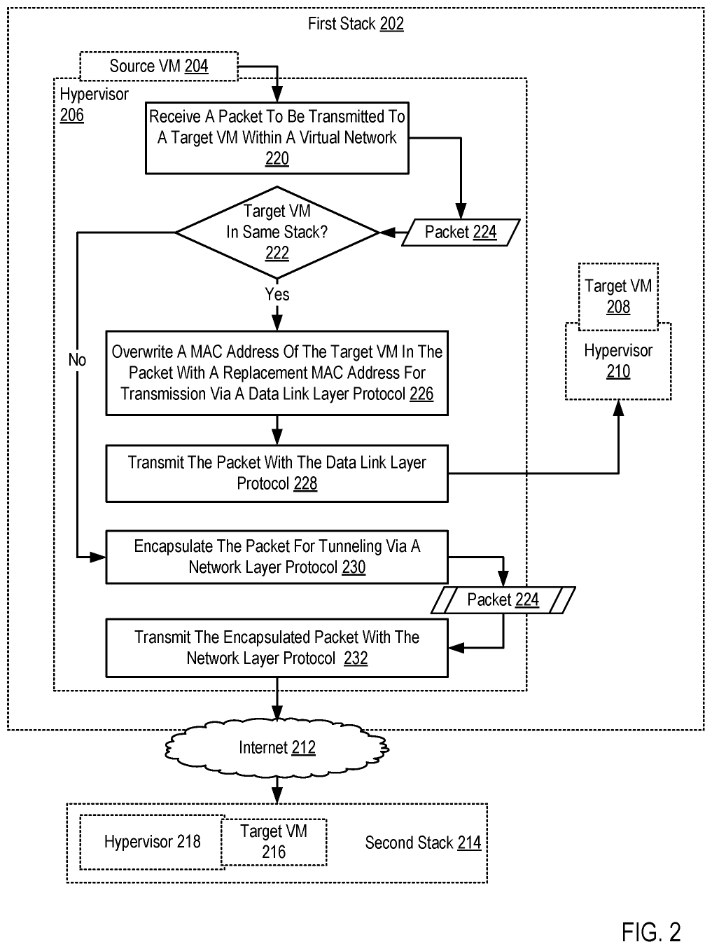

For further explanation, FIG. 2 sets forth a flow chart illustrating an example method for providing a hybrid virtual network according to embodiments of the present disclosure. The method of FIG. 2 includes receiving (220) from a source VM (204), by a hypervisor (206) of a first stack (202), a packet (224) to be transmitted to a target VM within a virtual network. The virtual network includes a plurality of VMs spanning a plurality of stacks. Each stack includes an aggregation of compute resources, storage resources, and network resources and separate stacks are coupled for data communications via a network level protocol. In the method of FIG. 2, the hypervisor (206) may receive (220) the packet (224) as a layer 2 ethernet frame through a system call by a virtual network communications adapter of the source VM. The ethernet frame may include a MAC address of the target VM.

The hypervisor (206), in the method of FIG. 2, continues by determining (222) whether the target VM is located in the first stack (202). Determining whether target VM is located in the first stack may be carried out by inspecting configuration information such as one or more tables or other data structures that indicates VM destination addresses (MAC addresses) included in the same virtual network as well as a stack identifier. If the target VM's destination address is included in the same virtual network and is associated with the stack identifier of the first stack (202) the hypervisor determines that the target VM is in the same stack.

The hypervisor may receive such configuration information from an orchestrator or controller. The configuration information may include MAC addresses of one or more VMs in the virtual network, IP addresses of one or more VMs in the virtual network, a specification of each VM's stack, and an IP address of at least one hypervisor of each stack.

If the target VM is located in the first stack, the method of FIG. 2 continues by overwriting (226) a MAC address of the target VM (208) in the packet (224) with a replacement MAC address for transmission via a data link layer protocol. In some embodiments, the MAC address of the target VM is overwritten with the MAC address of the hypervisor (210). The hypervisor then transmits (228) the packet with the data link layer protocol.

If the hypervisor (206) determines that the target VM (216) is not in the same stack, the method of FIG. 2 continues by encapsulating (230) the packet (224) for tunneling via a network layer protocol and transmitting (232) the encapsulated packet with the network layer protocol. The packet is encapsulated in some embodiments according to the VXLAN protocol. In some embodiments, encapsulating (230) the packet includes setting a destination IP address of the packet to an IP address of the hypervisor (218) in the second stack (214) that includes the target VM (216).

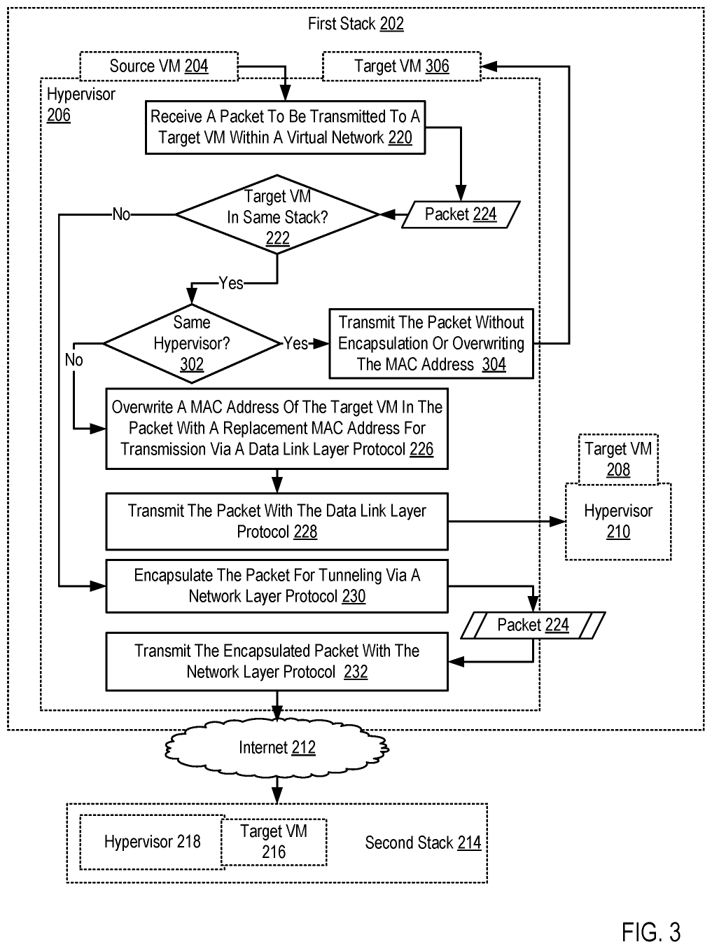

FIG. 3 sets forth a flow chart illustrating a variation of the previous method of providing a hybrid virtual according to embodiments of the present disclosure. The method of FIG. 3 operates in embodiments in which a hypervisor receives a packet that is not only directed to a VM in the same stack, but also to a VM hosted by the same hypervisor. In such an example, overwriting the destination of the MAC address with the hypervisor's MAC address and ‘transmitting’ the packet would be superfluous. To that end, after determining (222) that the target VM is in the same stack, the method of FIG. 3 continues by determining (302) whether the target VM (306) is hosted by the same hypervisor (206) as the source VM (204). If the target VM is hosted by the same hypervisor (206), the hypervisor (206) transmits (304) the packet to the target VM (306) without encapsulation of the packet and without overwriting the MAC address.

In view of the explanations set forth above, readers will recognize that the benefits of providing a hybrid virtual network according to embodiments of the present disclosure include:
Using a high-performance L2 MAC overwrite approach with distributed MAC address knowledge to process traffic inside one L2 domain within the same stack.
Using the more flexible, VXLAN tunneling for traffic among different L2 domains in different stacks.
Combining and leveraging two data forwarding technologies.

Exemplary embodiments of the present disclosure are described largely in the context of a fully functional computer system for providing a hybrid virtual network. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will also recognize that, although some of the exemplary embodiments described in this specification are oriented to software installed and executing on computer hardware, nevertheless, alternative embodiments implemented as firmware or as hardware are well within the scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of providing a hybrid virtual network, the method comprising:
receiving from a source VM (‘virtual machine’), by a hypervisor of a first stack, a packet to be transmitted to a target VM within a virtual network, the virtual network comprising a plurality of VMs spanning a plurality of stacks, wherein each stack comprises an aggregation of compute resources, storage resources, and network resources and separate stacks are coupled for data communications via a network level protocol;
determining whether the target VM is located in the first stack;
if the target VM is located in the first stack: overwriting a MAC (‘Media Access Control’) address of the target VM in the packet with a replacement MAC address for transmission via a data link layer protocol and transmitting the packet with the data link layer protocol; and
if the target VM is not located in the first stack: encapsulating the packet for tunneling via a network layer protocol and transmitting the encapsulated packet with the network layer protocol.

2. The method of claim 1, further comprising:
receiving by the hypervisor, configuration information that includes MAC addresses of one or more VMs in the virtual network, IP addresses of one or more VMs in the virtual network, a specification of each VM's stack, and an IP address of at least one hypervisor of each stack.

3. The method of claim 1, further comprising:
if the target VM is located in the first stack and is hosted by the same hypervisor, transmitting the packet to the target VM without encapsulation of the packet or overwriting the MAC address.

4. The method of claim 1, wherein the replacement MAC address further comprises a MAC address of a hypervisor hosting the target VM.

5. The method of claim 1, wherein encapsulating the packet further comprises setting a destination IP (‘Internet Protocol’) address of the packet to an IP address of the hypervisor in the stack that includes the target VM.

6. The method of claim 1, wherein each stack implements a private cloud.

7. The method of claim 1, wherein the packet is encapsulated according to a VXLAN protocol (‘Virtual eXtensible Local Area Network’).

8. An apparatus for providing a hybrid virtual network, the apparatus comprising a computer processor, a computer memory operatively coupled to the computer processor, the computer memory having disposed within it computer program instructions that, when executed by the computer processor, cause the apparatus to perform operations comprising:
receiving from a source VM (‘virtual machine’), by a hypervisor of a first stack, a packet to be transmitted to a target VM within a virtual network, the virtual network comprising a plurality of VMs spanning a plurality of stacks, wherein each stack comprises an aggregation of compute resources, storage resources, and network resources and separate stacks are coupled for data communications via a network level protocol;
determining whether the target VM is located in the first stack;
if the target VM is located in the first stack: overwriting a MAC (‘Media Access Control’) address of the target VM in the packet with a replacement MAC address for transmission via a data link layer protocol and transmitting the packet with the data link layer protocol; and
if the target VM is not located in the first stack: encapsulating the packet for tunneling via a network layer protocol and transmitting the encapsulated packet with the network layer protocol.

9. The apparatus of claim 8, the operations further comprising:
receiving by the hypervisor, configuration information that includes MAC addresses of one or more VMs in the virtual network, IP addresses of one or more VMs in the virtual network, a specification of each VM's stack, and an IP address of at least one hypervisor of each stack.

10. The apparatus of claim 8, the operations further comprising:
if the target VM is located in the first stack and is hosted by the same hypervisor, transmitting the packet to the target VM without encapsulation of the packet or overwriting the MAC address.

11. The apparatus of claim 8, wherein the replacement MAC address further comprises a MAC address of a hypervisor hosting the target VM.

12. The apparatus of claim 8, wherein encapsulating the packet further comprises setting a destination IP (‘Internet Protocol’) address of the packet to an IP address of the hypervisor in the stack that includes the target VM.

13. The apparatus of claim 8, wherein each stack implements a private cloud.

14. The apparatus of claim 8, wherein the packet is encapsulated according to the VXLAN protocol (‘Virtual eXtensible Local Area Network’).

15. A computer program product for providing a hybrid virtual network, the computer program product comprising a non-volatile computer readable medium and non-transitory computer program instructions embodied therein, the program instructions being executable by a computer to perform operations comprising:
receiving from a source VM (‘virtual machine’), by a hypervisor of a first stack, a packet to be transmitted to a target VM within a virtual network, the virtual network comprising a plurality of VMs spanning a plurality of stacks, wherein each stack comprises an aggregation of compute resources, storage resources, and network resources and separate stacks are coupled for data communications via a network level protocol;
determining whether the target VM is located in the first stack;
if the target VM is located in the first stack: overwriting a MAC (‘Media Access Control’) address of the target VM in the packet with a replacement MAC address for transmission via a data link layer protocol and transmitting the packet with the data link layer protocol; and
if the target VM is not located in the first stack: encapsulating the packet for tunneling via a network layer protocol and transmitting the encapsulated packet with the network layer protocol.

16. The computer program product of claim 15, the operations further comprising:
receiving by the hypervisor, configuration information that includes MAC addresses of one or more VMs in the virtual network, IP addresses of one or more VMs in the virtual network, a specification of each VM's stack, and an IP address of at least one hypervisor of each stack.

17. The computer program product of claim 15, the operations further comprising:
if the target VM is located in the first stack and is hosted by the same hypervisor, transmitting the packet to the target VM without encapsulation of the packet or overwriting the MAC address.

18. The computer program product of claim 15, wherein the replacement MAC address further comprises a MAC address of a hypervisor hosting the target VM.

19. The computer program product of claim 15, wherein encapsulating the packet further comprises setting a destination IP (‘Internet Protocol’) address of the packet to an IP address of the hypervisor in the stack that includes the target VM.

20. The computer program product of claim 15, wherein each stack implements a private cloud.
